(19) United States
(12) Patent Application Publication
(10) Pub. No.: US 2011/0253644 A1
(43) Pub. Date: Oct. 20, 2011

(54) Method and apparatus for filtering fluids

(76) Inventors: Robert J. Kolp, JR., Ivoryton, CT (US); Walter Tischbein, Killingworth, CT (US); James M. Bohora, Westbrook, CT (US)

(21) Appl. No.: 13/066,372

(22) Filed: Apr. 13, 2011

Related U.S. Application Data
(60) Provisional application No. 61/342,531, filed on Apr. 15, 2010.

(51) Int. Cl. B01D 35/22; B01D 29/00

(52) U.S. Cl. 210/767; 210/484; 210/232

(57) ABSTRACT

A method of filtering fluids uses a filter media through which angled filter hole bores are formed, all angled in the same direction and at about the same angle to the surface of the filter media and the filter media is oriented relative to the flow path of a fluid, at least some of which is to be filtered, such that the general flow is across the surface of the filter media and contrary to the direction of the filter hole bores and fluid to pass through the filter media must at least partially reverse direction, and a filter device formed with and orienting such a filter media according to the method.

### CROSS REFERENCE TO RELATED PROVISIONAL APPLICATION

This application claims the benefit of U.S. Provisional Application No. 61342531, filed Apr. 15, 2010.

### BACKGROUND OF THE INVENTION

A. Field of Invention

The present invention relates generally to methods and apparatus for filtering fluids and more particularly to a method and apparatus for removing small particles from a fluid and washing the filtering element to avoid clogging.

B. Description of Related Art

In a number of fields, it is desirable to filter particles from a fluid. Particulate matter can be a pollutant that causes fluid systems to fail, particularly in control systems that rely on valving as a means of flow control. Particles of matter suspended in a fluid can lodge in valves, nozzles, or other fluid system components and cause such components to fail in their performance. In some applications, a volume of filtered fluid is drawn off a main body of relatively unfiltered fluid, for example, in aviation where it is useful to draw from a flow of relatively coarsely filtered fuel, a volume of finely filtered fluid for use in control systems. A common means for removing particulate matter from fluids involves the filtering of the fluid by passing it through a filter media with openings that are smaller than the minimum tolerable particle size. Wire mesh screens, examples of which are shown in FIGS. 5 and 6 as screen 205 with openings 207, are frequently used as a filter media as are screens fabricated by multiple drilled holes, for example, in a thin sheet of material, frequently metal, as shown in cross section in FIG. 7 as filter 200 with holes 223. A common difficulty with filters is the clogging of the filter media by accumulated particles that become lodged in the hole openings and held there either by being physically jammed into the opening or being held in place by the pressure differential required for the filter to function, or by a combination of these factors. For the purpose of illustration, a debris ball 201 is shown in the prior art FIGS. 5, 6, and 7. Methods of ameliorating filter clogging include removal and replacement of the filter or washing the particles off the filter media. A convenient method of unclogging filters is to wash the filter media in place, without removal from the component or system. When it is possible to maintain a flow of fluid across the surface of the filter media, it may be possible to use the fluid from which the filtered fluid is drawn as the washing agent. Such filters may be described as self-washing or simply as “wash filters” and examples of such devices are shown in U.S. Pat. No. 5,591,339 to Robinson, U.S. Pat. No. 3,119,3102 to Bottoms, U.S. Pat. No. 4,003,836 to Stearns, U.S. Pat. No. 3,674,154 to Sicard, and U.S. Pat. No. 3,109,809 to Verrando.

These self-washing filters generally employ designs that rely on relatively high speeds of fluid flow over the face of the filter media to physically dislodge particles that would otherwise accumulate and clog the filter. Various flow path restrictions or diversions are used to achieve high velocity flow localized over the surface of the filter media. Since the desire is to draw off at least some fluid through the filter and minimizing or eliminating the need to apply a negative pressure to the filtered fluid side of the filter, it is desirable to avoid creating a Venturi effect of reduced or even negative fluid pressure at the surface of the filter. Nevertheless, such filters may eventually experience clogging and a more clog resistant filter that is economical to manufacture is desirable.

### SUMMARY OF THE INVENTION

The present invention comprises the method of forming a filter media wherein laser drilled holes are angled with respect to the filter surface and arranging the filter media in a component such that the general direction of flow of the fluid to be filtered is more than 90 degrees from the direction of flow through the filter hole bores. The method is achieved by orienting the filter surface such that the general flow not through the hole bores is parallel to the filter surface, while the flow through the hole bores is at least partially reverse in direction relative to the general flow direction across the filter surface. The difference between the hole bores of the present invention and those of a prior art device is see in the contrast of FIG. 3 (present invention) and FIG. 7 (Prior Art). Although a hole bore angle of 45 degrees may be optimum, a range of hole angles may be used with the range from about 30 to about 60 degrees expected to be most useful. As a result of the obtusely angled filter hole, for a particle suspended in the unfiltered fluid to enter the hole, it must overcome its momentum in order to change direction to a partially reverse direction. The opening of each filter hole bore through the filter surface is elliptical with a major axis longer than the diameter of the hole, the minor axis of the opening is equal to the diameter of the hole. Since the hole is at an angle, at the trailing edge of the hole bore opening, the angle between the filter surface and the hole bore is greater than 90 degrees and therefore presents an edge that is less sharp and less likely to catch and hold a particle. While a round wire mesh has the same sort of blunting of the trailing hole edge, as shown in FIG. 6, the round wire offers a radiused inlet on all edges, which acts as a funnel and allows the dirt to penetrate below the surface where it less likely to be washed off. Since the upstream fluid contact edge of a hole in the present invention is sharp, less than 90 degrees, a substantial amount of the fluid is expected to tend to continue across the filter hole opening and this will assist in flushing the filter surface. It is expected that if the upstream edge of the hole was rounded, as in a wire mesh, and had a radius, the fluid would have a greater tendency to stay attached and flow around the edge into the filter hole. With the inherent resistance to clogging, the fluid can be flowed past the filter surface at a lower velocity without reducing the washing effect. Allowing a lower velocity flow eliminates the need to restrict the fluid flow path and avoids the reduction of local fluid pressure that may accompany flow restrictions, which could negatively affect the performance of the filter. Generally, as the primary flow rate is lowered, the reverse side hole angle may be increased with the consequence of obtaining better washing and delayed or prevented clogging of the filter.

The filter media can be arranged to form an apparatus in accord with the present invention in a variety of shapes including a simple tubular shape as is shown in the drawings or a conical shape as also shown. The present invention further comprises such a fluid filter apparatus constructed and used in accord with the foregoing method.

The principle aim of the present invention is to provide a new and improved method and device that meets the foregoing requirements and is capable of filtering particles from a fluid system with reduced tendency to become clogged.

Other objects and advantages of the invention will become apparent from the Description of the Preferred Embodiments and the Drawings and will be in part pointed out in more detail hereinafter.

The invention consists in the features of construction, combination of elements and arrangement of parts exemplified in the construction and method as hereinafter described.

### BRIEF DESCRIPTION OF THE DRAWINGS

FIG. 1 is an enlarged cross sectional view of a first preferred embodiment of a filter component in accord with the present invention, with an arrow showing the expected flow direction and path.

FIG. 2 is an enlarged view of the surface of a portion of filter media in accord with the present invention, showing section line 3-3.

FIG. 3 is an enlarged cross sectional view of a portion of a filter media in accord with the present invention, taken along section line 3-3 as shown in FIG. 2, and a debris ball, with an arrow showing the expected flow direction and path.

FIG. 4 is an enlarged cross sectional view of a second preferred embodiment of a filter component in accord with the present invention, with an arrow showing the expected flow direction and path in a first direction.

FIG. 5 is a top view of a section of a wire mesh filter, comporting with the Prior Art and a debris ball.

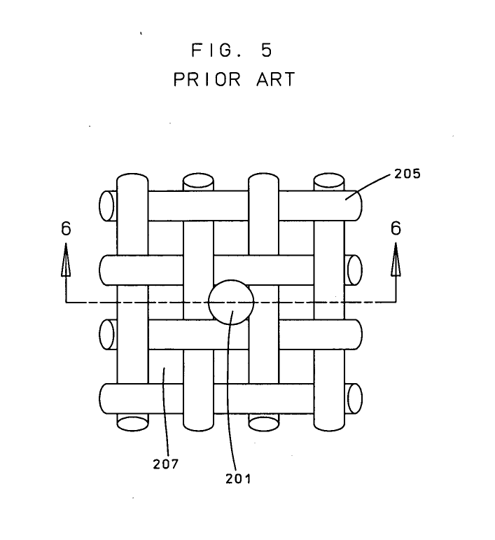

FIG. 6 is a cross sectional view of a section of a wire mesh filter, comporting with the Prior Art and a debris ball.

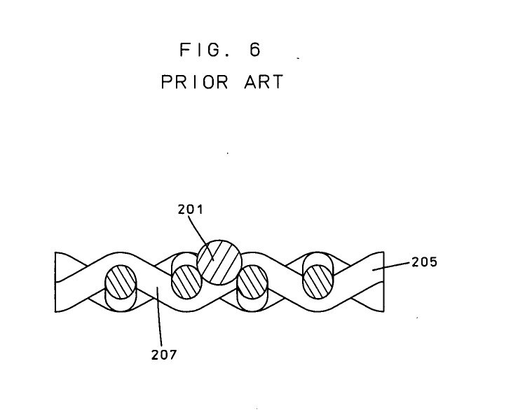

FIG. 7 is a cross sectional view of a section of a bored hole filter, comporting with the Prior Art and a debris ball, with an arrow showing the expected flow path.

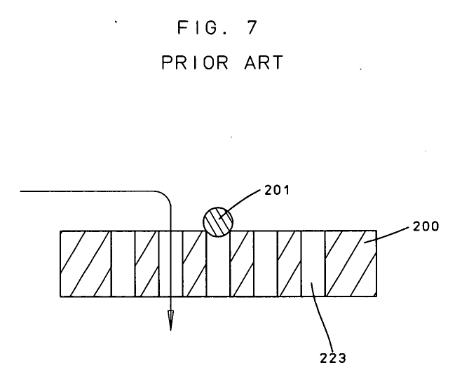

### DESCRIPTION OF THE PREFERRED EMBODIMENT(S)

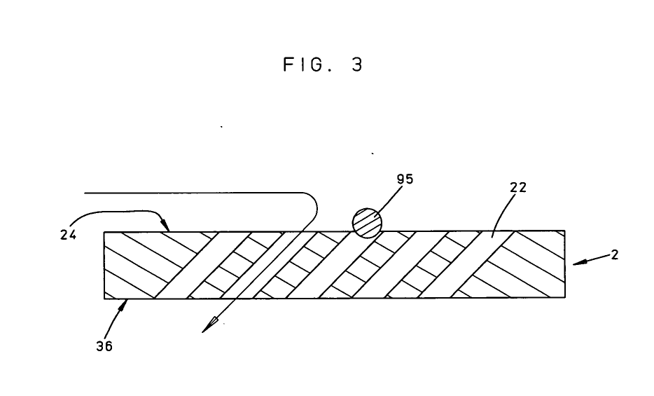

The method of the present invention comprises the filtering of a fluid by forming a filter with multiple drilled filter holes that are angled with respect to the filter surface and with the general direction of flow of the fluid to be filtered such that the fluid to be filtered must change flow direction by more than 90 degrees. The holes may be laser drilled or drilled by any conventional means that produces a generally cylindrical bore through the material of the filter. Although a hole angle of 45 degrees between the hole axis and the surface of the filter material may be optimum, hole angles of less than about 30 degrees or more than about 60 degrees might be used but are not expected to be satisfactory due to the length on the hole bore, in the case of lower angles, or due to loss of the benefits of the present invention. For the desired effect, it is further necessary to orient the filter material such that the filter surface is either parallel to or slightly angled with respect to the general direction of flow of the fluid to be filtered and the axes of the hole bores are at an angle of greater than 90 degrees to the general direction of flow of the fluid to be filtered. As a result of the obtusely angled filter hole, relative to the flow path, for a particle, an example of which is designated 95 in FIG. 3, suspended in the unfiltered fluid to enter the hole opening, it must overcome its momentum in order to change direction to an at least partially reverse direction. The hole bores have generally cylindrical inner walls that intersect the filter material surface at an elliptical opening of each filter hole, the opening having a major axis longer than the inside diameter of the hole bore, and the minor axis of the opening is equal to the diameter of the hole bore.

It is anticipated that the length of the hole bores is dependent upon the hole bore angle relative to the surface of the filter, and will adversely relate to the resistance to flow through the filter and to the cost of manufacture. Conversely, the self washing aspect of the filter surface is expected to increase as the angle between the hole bore and the filter surface at the trailing end of the hole opening increases. An optimum compromise may be to angle the hole bores at 45 degrees to the filter surface such that the angle of the hole bore to the filter surface at the trailing edge is 135 degrees. The minimization of the length of the hole bores through the filter material is expected to be desirable. To minimize the length of the hole bores, the holes are angled in line with, away from and parallel to, the general flow direction of the fluid to be filtered and are not angled in any other direction. The major axis of the hole opening being parallel to the general flow direction, the trailing edge of the hole opening intersects the filter surface at an angle greater than 90 degrees and the leading edge of the hole opening intersects the filter surface at an angle less than 90 degrees. The direction of the flow of the fluid to be filtered is away from the leading edge and toward the trailing edge, which therefore presents an edge that is less sharp and less likely to catch and hold a particle 95. With the inherent resistance to clogging, the fluid can be flowed past the filter surface at a lower velocity without reducing the washing effect. Allowing a lower velocity flow eliminates the need to restrict the fluid flow path and avoids the reduction of local fluid pressure that may accompany flow restrictions, which could negatively affect the performance of the filter, or the system within which the filter is used. Generally, as the primary flow rate is lowered, the hole bore angles may be increased without compromising the flow through the filter and with the beneficial consequence of obtaining better washing and delayed or prevented clogging of the filter. The filter surface is oriented in either a cylindrical shape or a conical shape, with the cylindrical shape being preferable if not all of the fluid need be filtered. With the filter surface cylindrically shaped, the bulk of the fluid can be flowed through the filter without being filtered and the fluid that passes laterally through the filter hole openings and bores and which thus has been filtered can be drawn off or collected and used as needed.

A conical configuration may be useful when all fluid needs filtering as the filter surface could traverse a flow path, with the base of the conical shape secured to the inside walls of the fluid conduit and the apex of the conical shape in the center of the flow. With a filter in a conical configuration, the hole bores are drilled from the outer surface inward toward the axis of the conical shape and in the direction of the interior apex from a direction towards the base of the conical shape. Therefore, from the interior of the conical shape, the hole bores are oriented and angled from the apex direction toward the base on the outside and the flow path of the fluid being filtered must change by more than 90 degrees regardless of whether the general flow path is toward the outside or toward the inside of the conical shape, ie, whether in the apex to base direction of in the opposite, base to apex direction. The angle of the hole bores to the flow direction, absent a change in the angle of the hole bores to the filter surface, is reduced by one half of the angle of the apex of the conical shape. To maintain an optimum hole bore angle to flow path, the hole bore angle to the filter surface would be varied accordingly.

The method of the present invention comprises the construction and use within a fluid system of a filter having an array of hole bores and openings as described above, such that the general flow direction of the fluid to be filtered must be changed by more than 90 degrees in order to pass through the filter holes. Variations in the size of the filter and the diameter of the hole bores may be used as may be desired without departing from the method of the present invention. Similarly, the material of which the filter is fabricated may be changed depending upon the requirements of the specific application of the invention. It is anticipated that since the length of the hole bores will increase as the hole bore angle varies from 45 degrees, the fluid resistance of the filter will change accordingly.

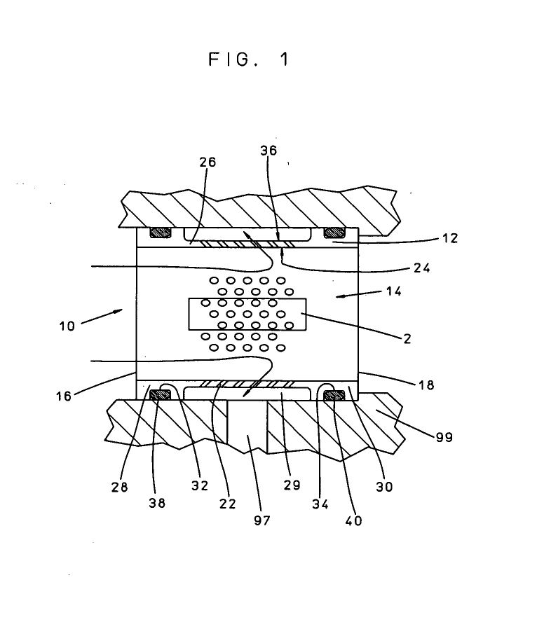

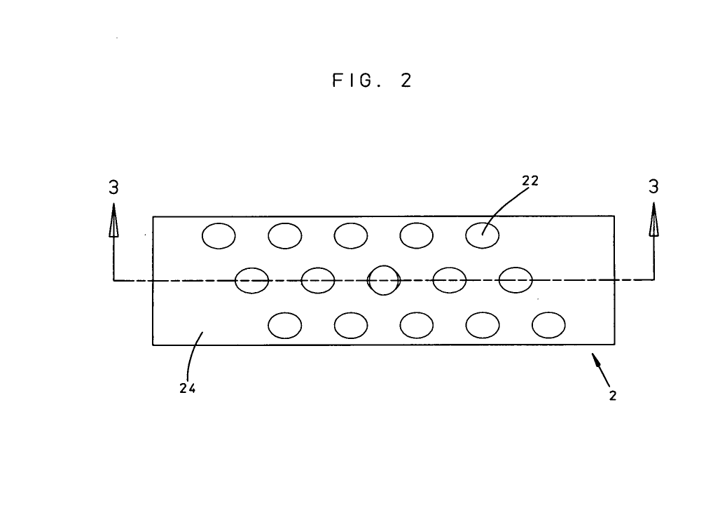

With reference to the Figures wherein like numerals represent like parts, a first preferred embodiment of a fluid filter apparatus constructed in accordance with the method of the present invention is generally designated by numeral 10 in FIG. 1, with an arrow therein showing the expected direction of general flow. Filter apparatus 10 comprises a generally cylindrical body 12 surrounding a central bore 14 extending from a inlet end 16 to an outlet end 18 and a cylindrical filter section 26 axially extending between the two end sections 16 and 18. The majority of the flow into filter 10 is expected to pass through central bore 14 of filter 10 without being filtered. Filter section 26 is perforated by numerous small filter holes 22. A magnified view of a portion 2 of the filter section 26 is shown in FIGS. 2 and 3 with the direction of flow toward and through filter portion 20 being illustrated by an arrow in FIG. 3. Only the fluid passing through filter section 26 is filtered by filter 10. The inside surface 24 of body 12 is cylindrical and defines central bore 14. The outer surface 36 of filter section 26 is of reduced diameter, less than the outer diameter of filter body ends 16 and 18, which comprise annular ridges 28 and 30, respectively, which surround and are raised radially outward from filter section 26. Both ridges 28 and 30 comprise annular grooves 32 and 34 that receive an annular seal 38 or 40, respectively. When filter device 10 is installed in a bore or tube, an exemplar of which is partially shown in FIG. 1 as structure 99, the outer surfaces 28 and 30 of body ends 16 and 18, and/or the annular seals 38 and 40 installed therewith, sealingly engage the inside of the installation bore 99 and an annular chamber 29 is thus created between the reduced diameter outer surface 36 of filter section 26 and the inside of the installation bore 99. The annular chamber 29 communicates with the central bore 14 only through filter holes 22 and it is expected that an intersecting bore or tube, an exemplar of which is shown in FIG. 1 as bore 97, is provided by which the filtered fluid that has entered annular chamber 29 through filter holes 22 exits chamber 29, to be used as desired. Each hole 22 is essentially a short cylindrical bore that has an axis, which is expected to generally intersect the axis of the central bore 14. It is to be anticipated that variations of exact hole angles in filter 10 are to be expected without departing from the spirit of the present invention, it not being critical to the invention that the hole bores exactly intersect the filter axis. It is however, convenient to describe the hole bores as intersecting the filter bore 14 axis to indicate the general orientation of the hole bores and to contrast to the prior art. For example, FIG. 2 shows conventional filter holes 223 such as might be used in a filter device configured similarly to device 10. The axes of conventional prior art filter holes 223, as shown in FIG. 2, labeled “Prior Art”, are relatively normal to the filter surface and would be expected to generally intersect the axis of the central bore of a prior art filter in a strictly radial fashion, forming a 90 degree angle therewith. The axes of filter holes 22 of the present invention, in contrast to the prior art filter, are acutely angled with respect to surface 24 of filter section 26 such that the axis of the bore of a particular hole 22 is expected to intersect the axis of central bore 14 at an acute angle and at a point closer to the outlet end 18 than the particular hole 22. All the hole bore axes of all holes 22 are expected to intersect the axis of the central bore 14 at approximately the same angle, and device 10 is to be installed such that the direction of flow from the central bore 14 through holes 22 into chamber 29 is at least partially contrary to the direction of flow generally through the central bore 14 of device 10, that is toward inlet end 16. In FIG. 2, the openings of holes 22 in the inner surface 24 of filter section 26 are shown and it can be seen that, as described above, the openings are elliptical and the major axis of the ellipse is generally parallel to the axis of central bore 14.

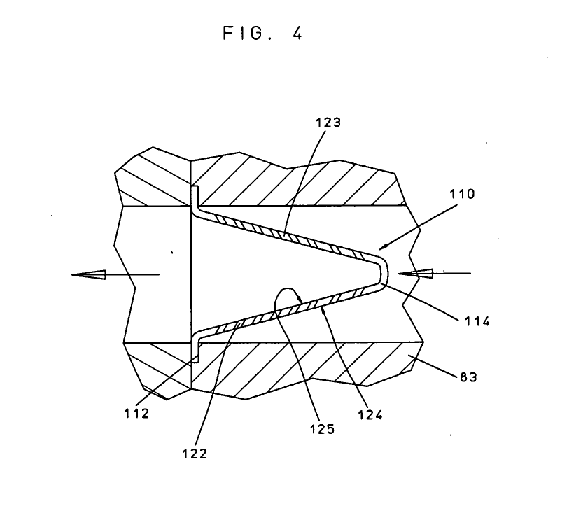

A second embodiment of a filter device employing and constructed in accordance with the method of the present invention is generally designated by numeral 110 in FIG. 4. Filter device 110 is generally conical having an annular flange 112 at the base, an apex 114, and a conical filter section 123 therebetween. The conic angle of filter section 123 may vary, with the expectation that the self washing ability of the filter in inversely dependent upon the conic angle and will be modified accordingly. The inner surface of filter section 123 is denominated 125 and the outer surface of filter section 123 is denominated 124. Numerous holes 122 are formed in the filter section 123 and are generally equally spaced thereon. With the exception of the exact placement of holes 122, which are not necessarily symmetrically placed, device 110 is generally symmetrical about an axis of symmetry extending from the center of apex 114 to the center of a circle defined by annular flange 112. It will be appreciated that apparatus 110 is expected to be used by securing flange 112 to the inside of a flow passage, within an installation structure an example of which is shown in FIG. 4 and designated 93, wherein flow may proceed in a first direction from apex 114 toward flange 112 as shown by arrow in FIG. 4, or alternatively in a second, opposite direction from flange 112 toward apex 114. As with holes 22, holes 122 have bores with axes, which intersect the axis of symmetry of filter 110 at an acute angle, the vertex of which is closer to apex 114 than the respective hole 122. Holes 122 are formed at an acute angle to the filter surfaces 124 and 125 and to the expected overall flow path. When flange 112 is fixed in installation bore 93, device 110 traverses the flow path and all flow past the device 110 must flow through holes 122. The flow path through holes 122 is similar to that shown in FIG. 3 and requires the fluid being filtered to partially reverse direction. The orientation of the holes 122 are in accord with the present invention regardless of whether the overall flow direction is from the first direction, from apex 114 toward flange 112, or the second, opposite direction. If the overall flow direction is in the first direction, particles washed past holes 122 will be expected to accumulate about the flange 112 end of filter device 110 and if the overall flow direction is in the second direction, from flange 112 to apex 114, particles washed past holes 122 will be expected to accumulate in apex 114.

As will be anticipated from the illustrated embodiments 10 and 110, which serve as examples of devices for carrying out the method of the present invention, a variety of potential configurations can be usefully designed using the main features of the method, namely, a filter surface parallel or at a slight angle to the general flow path and angled hole bores that require at least partial reversal of flow path to traverse the filter.

I claim:

1. A method of filtering fluids comprising
forming of a filter media comprising a first surface, a second surface and holes through the filter media comprising hole openings in the first and second surfaces connected by hole bores through the filter media, the hole bores being formed at an acute angle to the filter media surface; and
orienting the filter media in a flow of fluid to be filtered such that the angle of the hole bores to the flow of the fluid to be filtered is greater than 90 degrees.

2. The method of claim 1, wherein orientation of the filter media further comprises exposing the first filter surface to a flow of fluid to be filtered such that at least some of the fluid to be filtered passes through the filter media and the method further comprises separating and using the fluid that has passed through the filter media.

3. The method of claim 2, wherein the angle between the surfaces of the filter media and the hole bores is at least about 30 degrees and not more than about 60 degrees.

4. The method of claim 3, wherein the step of orienting the filter media further comprises forming the filter media in a cylindrical shape with the first surface forming an inner wall of a flow passage through which the fluid to be filtered flows.

5. The method of claim 4, wherein the flow passage comprises an inlet end and an outlet end and the filter media hole bores are angled inward toward the outlet end, with each hole opening on the first surface closer to the outlet end than the respective hole opening in the second, outer surface.

6. The method of claim 3, wherein the step of orienting the filter media further comprises forming the filter media in a conical shape having an apex and a base and the first surface is conical shaped on the outside of the filter media and further comprising a conical inside second surface formed on the inside of the filter media, and the hole bores are angled such that for each hole opening through the first, outer surface is closer to the filter media base than the respective hole opening through the second surface.

7. The method of claim 6, further comprising the step of securing the base of the filter media to the wall of a flow passage.

8. A filter device A method of filtering fluids comprising filter media with a first surface, a second surface and holes through the filter media comprising hole openings in the first and second surfaces connected by hole bores through the filter media, the hole bores being formed at an acute angle to the filter media surfaces, the filter media mounted to expose one of the surfaces to a flow of fluid to be filtered such that the angle of the flow of filtered fluid through the hole bores to the flow of the fluid to be filtered is greater than 90 degrees.

9. The filter device of claim 8, wherein the angle between the surfaces of the filter media and the hole bores is at least about 30 degrees and not more than about 60 degrees.

10. The filter device of claim 9, wherein the filter media is formed in a cylindrical shape with the first surface forming an inner wall of a flow passage through which the fluid to be filtered flows.

11. The filter device of claim 10, wherein the flow passage comprises an inlet end and an outlet end and the filter media hole bores are angled inward toward the outlet end, with each hole opening on the first surface closer to the outlet end than the respective hole opening in the second, outer surface.

12. The filter device of claim 9, wherein the filter media is formed in a conical shape having an apex and a base and the first surface is conical shaped on the outside of the filter media and further comprising a conical inside second surface formed on the inside of the filter media, and the hole bores are angled such that for each hole opening through the first, outer surface is closer to the filter media base than the respective hole opening through the second surface.

13. The filter device of claim 12, wherein the device further comprises an annular flange at the base of the filter media for securing the filter device within a flow passage.
